(19) United States
(12) Patent Application Publication
(10) Pub. No.: US 2005/0011554 A1
(43) Pub. Date: Jan. 20, 2005

(54) Modular regulator

(75) Inventors: Mario Davila, Converse, TX (US); Dan Woehr, San Antonio, TX (US)

Correspondence Address: Ralph W. Selitto, Jr.;McCarter & English, LLP, Four Gateway Center, 100 Mulberry Street, Newark, NJ, 07102, US

(73) Assignee: Taprite-Fassco Manufacturing Inc.

(21) Appl. No.: 10/766,150

(22) Filed: Jan. 27, 2004

Related U.S. Application Data
(60) Provisional application No. 60/443,275, filed on Jan. 28, 2003.

(51) Int. Cl. G05D 16/06

(52) U.S. Cl. 137/269; 137/505.42

(57) ABSTRACT

A regulator for controlling and modulating the pressure of supplied gases includes an orifice, and a stem extending through the orifice. The regulator exhibits a flow capacity that depends, at least partially, on the relative dimensions of the orifice and the stem. The flow capacity of the regulator may be selectively changed via selective replacement of the stem with a stem of a different dimension. The regulator may include a mounting base, and a module coupled to the mounting base and that includes the orifice and the stem. The flow capacity of the modular regulator may be selectively changed, for example, by detaching the module from the mounting base, and either replacing the module with another module having an orifice of the same dimension and a stem of a different dimension, or by exchanging the stem with another stem of a different dimension while retaining the module.

### CROSS-REFERENCE TO RELATED APPLICATION

This application is a §111(a) application relating to commonly owned co-pending U.S. Provisional Application Ser. No. 60/443,275, entitled “Modular Regulator,” filed Jan. 28, 2003.

### FIELD OF THE INVENTION

The present invention relates to regulators and, more particularly, to a new and improved regulator for use in controlling and modulating the pressure of supplied gases.

### BACKGROUND OF THE INVENTION

Gas regulators are a staple of industry, being used to control and maintain the pressure of gases for a wide variety of industrial, commercial and residential applications. Gas regulators are typically precision devices, which are able to maintain relatively constant output pressures over a wide range of input pressures. One problem with many existing pressure regulators is that they are designed to provide only one predetermined output pressure. Consequently, if a user requires a wide range of output pressures, then he or she must purchase and stock different pressure regulators. This can become very expensive for the user. Moreover, manufacturers of existing pressure regulators must produce and stock several different regulators and components thereof, resulting in increased costs of production and inventory.

Another concern with existing regulators is that when a regulator is in need of maintenance or replacement, it can represent a sizeable cost in both time and labor. For instance, maintenance of a regulator or replacement of components thereof typically requires disassembling many or all of the components of the regulator. In addition, maintenance and replacement of existing regulators typically require disconnecting them and their often-associated equipment, such as flow meters, valves and the like, from a gas supply to which they are attached. Experience has also shown that, because of the delicate nature of the regulator and the interplay between its components, inattention or carelessness during maintenance, as well as the removal and installation processes themselves, may result in damage or misadjustment to the regulator. Therefore, any minimization of disassembly of the regulator components and elimination of the need to remove the regulator from the gas system during maintenance or replacement would greatly reduce time and labor costs. At the same time, the chance of any damage to or misadjustment of the regulator would be diminished.

Finally, a major objective in designing a regulator is to protect the regulator's internal components from harmful conditions while the regulator is in use. For instance, a regulator is often subject to pressures that exceed the regulator's normal operating specification. Many existing regulators are designed to only handle pressures that slightly exceed the regulator's normal operating specification, but lack sufficient safety mechanisms to relieve pressures that grossly exceed the regulator's normal operating specification. Without an appropriate safety relief mechanism, the regulator or the gas system to which the regulator is attached is likely to be damaged.

Another example of a harmful condition is the introduction of foreign matter within the regulator itself. Dust, debris and other small particles can affect the performance of the regulator or, in some cases, damage the regulator. Accordingly, protection of the internal components of a regulator is paramount.

Various pressure regulators have been proposed in the past for addressing the aforesaid concerns. For instance, U.S. Pat. No. 4,966,183 to Williamson (the “Williamson '183 patent”) discloses a gas pressure regulator that contains a relief valve for relieving pressures greater than the desired output pressure. The Williamson '183 patent discloses that the relief valve can be adjusted manually or electrically. However, manual or electrical adjustment is not always reliable, such that manual adjustment invites room for human error, while electrical adjustment would fail in the event of power outages. As a result, the desired output pressure of the regulator may not always be achieved.

The Williamson '183 patent also discloses the use of a filter to prevent foreign matter from passing through a bleed orifice within a diaphragm assembly. However, the filter's location does not prevent foreign matter from substantially traveling through the regulator that could affect other pressure regulation elements of the regulator. As a result, the accumulation of foreign matter could buildup in areas of the regulator other than the bleed orifice. As a result, the desired output pressure of the regulator can be affected or the regulator could be damaged.

In addition, the Williamson '183 patent does not disclose that the regulator can remain attached to the gas system while being repaired. As a result, removal of the entire regulator from the gas system for repair or replacement would involve additional cost in time and labor.

U.S. Pat. No. 5,279,327 to Alsobrooks (the “Alsobrooks '327 patent”) discloses a fluid pressure regulator that includes a valve insert that sets the flow capacity of the regulator. However, the Alsobrooks '327 patent does not disclose whether the regulator can accommodate valve inserts that allow for the provision of different flow capacities. Accordingly, different pressure regulators must be purchased and stocked in inventory if different flow capacities are desired.

U.S. Pat. No. 6,298,828 to Concialdi (the “Concialdi '828 patent”) discloses a fuel pressure regulator that includes a replaceable fuel return orifice element mounted within the regulator housing. The Concialdi '828 patent discloses that by replacing the element, the orifice contained therein can be sized to adjust the fuel pressure. However, the Concialdi '828 patent discloses that replacement of the orifice element requires a complete disassembly of the regulator housing. As a result, additional labor costs would be incurred.

U.S. Pat. No. 6,276,392 to Hendrickson (the “Hendrickson '392 patent”) discloses a liquid pressure regulator for use with water distribution systems. The Hendrickson '392 patent discloses the use of a replaceable spring that corresponds to a desired outlet pressure. However, the Hendrickson '392 patent does not disclose means for the safe release of fluid pressure greater than that of the capacity of the regulator.

Finally, none of the regulators covered by the aforementioned patents contain an appropriate safety mechanism that enable them to relieve pressures that grossly exceed their respective normal operating specifications.

### SUMMARY OF THE INVENTION

The present invention improves upon gas pressure regulators as described in the prior art. The most prominent feature of the regulator is that it provides a user with the flexibility to change the capacity of the gas system to which the regulator is attached. In this regard, the regulator accommodates interchangeable modules that are rated for different flow capacities. Each module has a stem whose diameter is rated for a specific flow capacity. For example, if a user has a module rated for a maximum of 10 scfm, and wishes to increase the capacity of the gas system to 15 scfm, the user can simply replace the 10 scfm module with a 15 scfm module. As a result, the regulator has an advantage in that the user need only purchase and stock one regulator and different modules and, thus, the user's costs are reduced. Similarly, a manufacturer and distributor need only stock components for one regulator and several different stem sizes, rather than stocking components for several different regulators.

In addition, the regulator includes a base that provides an interface between the regulator's module and the system to which the regulator is attached. Thus, if maintenance or replacement of a module is necessary, all a user must do is remove the module without having to disconnect the entire regulator and its often-associated components, such as gauges and couplings, from the gas system. This reduces both time and labor costs when maintenance or replacement is carried out.

The regulator also features a centrally located body plug within a regulator body, which allows for the replacement of a filter, which prevents foreign objects from entering the regulator. This eliminates the need to substantially disassemble the regulator components when replacing the filter. Along these lines, the filter is located in a position that greatly reduces the amount of foreign matter from entering into the regulator. This helps prevent inefficiencies of or damage to the regulator.

The regulator also includes a diaphragm assembly that allows for the relief of pressures that exceed the regulator's normal operating specification, as well as safety components that allow for the release of pressures that grossly exceed that of the regulator's normal operating specification. Accordingly, the safety mechanism prevents or reduces damage to the regulator's components and to the gas system to which the regulator is attached.

Specifically, the present invention has been adapted for use in the supply of carbon dioxide gas for carbonated beverage dispensing. However, the present invention can be utilized in other scenarios, environments and conditions.

Further features and advantages of the invention will appear more clearly on a reading of the detailed description of a preferred embodiment of the invention, which is given below by way of example only with reference to the accompanying drawings.

### BRIEF DESCRIPTION OF THE DRAWINGS

For a better understanding of the present invention, reference is made to the following detailed description of an exemplary embodiment considered in conjunction with the accompanying drawings, in which.

FIG. 1 is a top perspective view of a regulator constructed in accordance with an exemplary embodiment of the present invention.

FIG. 2 is a cross-sectional view, taken along section line II-II and looking in the direction of the arrows, of the regulator shown in FIG. 1.

FIG. 3a is a top plan view of a base employed by the regulator shown in FIGS. 1 and 2.

FIG. 3b is a cross-sectional view, taken along section line IIIb-IIIb and looking in the direction of the arrows, of the base shown in FIG. 3a.

FIG. 3c is a cross-sectional view, taken along section line IIIc-IIIc and looking in the direction of the arrows, of the base shown in FIG. 3a.

FIG. 4a is a top plan view of a body employed by the regulator shown in FIGS. 1 and 2.

FIG. 4b is a cross-sectional view, taken along section line IVb-IVb and looking in the direction of the arrows, of the body shown in FIG. 4a.

FIG. 4c is a cross-sectional view, taken along section line IVc-IVc and looking in the direction of the arrows, of the body shown in FIG. 4a.

FIG. 5 is an exploded perspective view of pressure regulation elements of the regulator shown in FIG. 2.

FIGS. 6a and 6b are exploded perspective views of a pair of safety elements of the regulator shown in FIG. 2.

FIG. 7 is an exploded perspective view of the regulator of FIG. 1 shown attached to a gas system and to a mounting bracket.

### DETAILED DESCRIPTION OF THE DRAWINGS

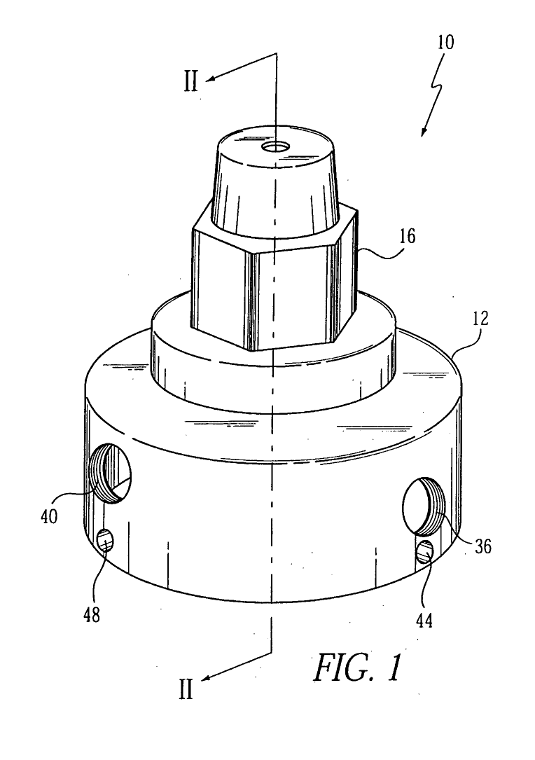

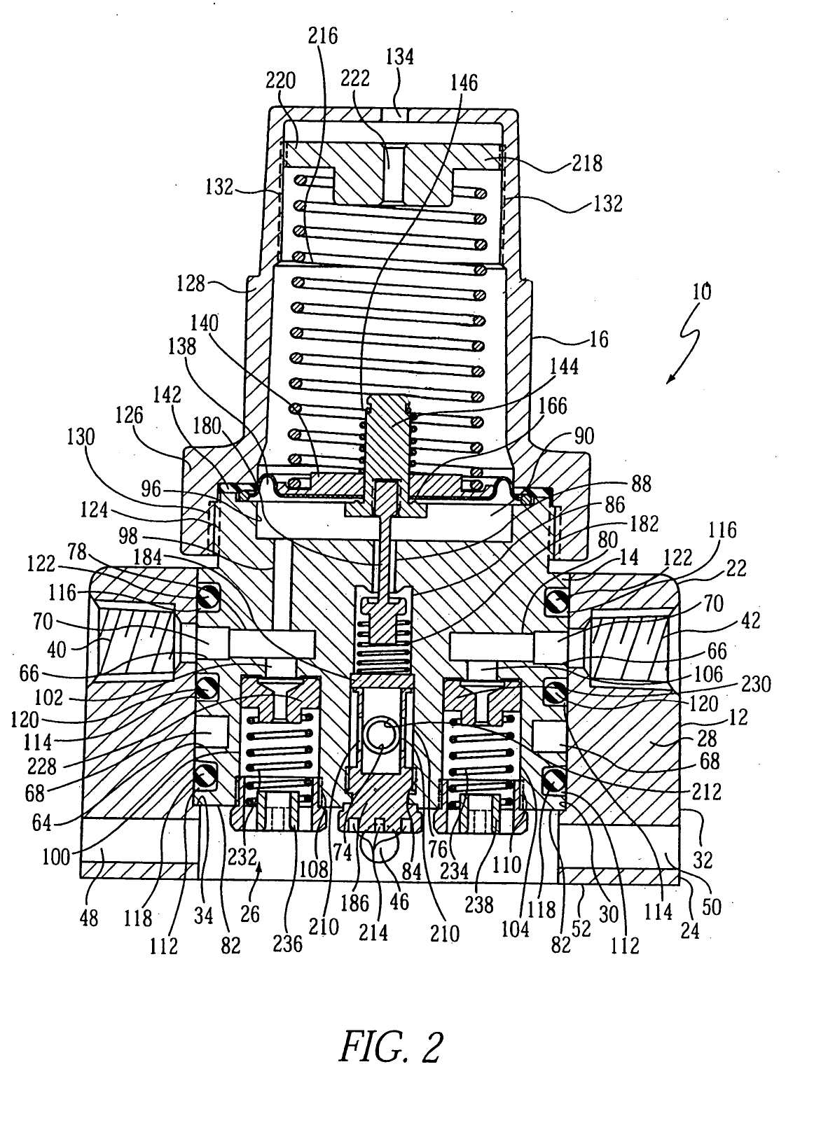

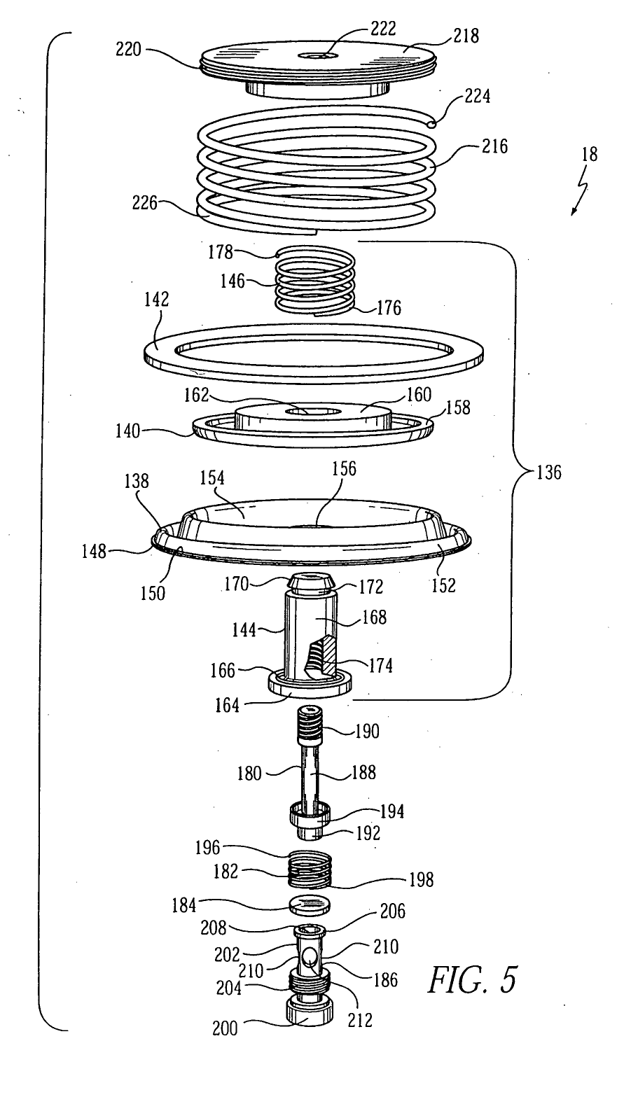

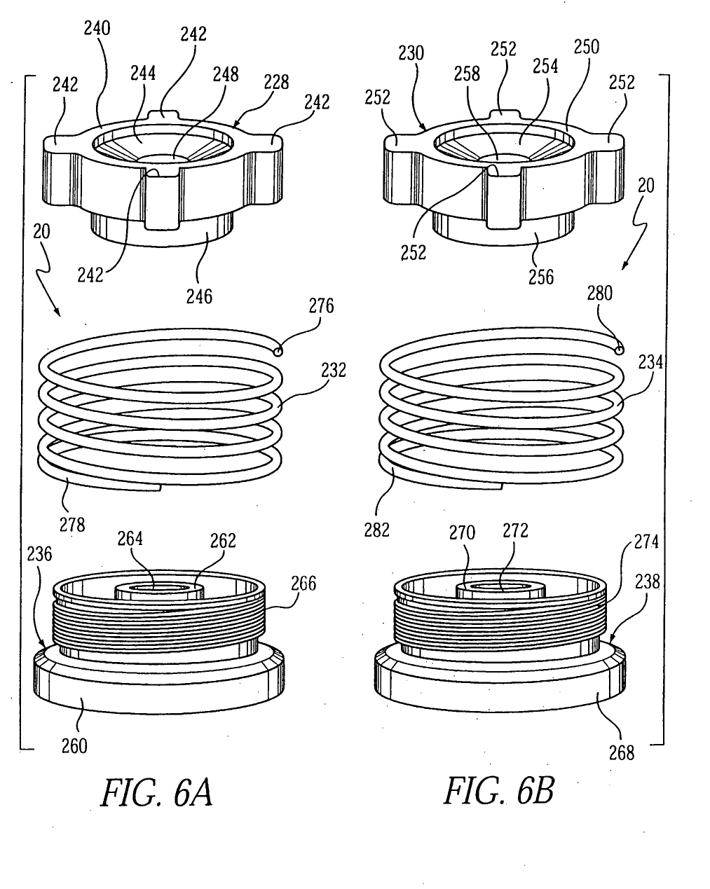

Referring to FIGS. 1 and 2, a modular regulator 10 includes a cylindrical-shaped base 12, a cylindrical-shaped body 14 (see FIG. 2) and a bonnet 16. The base 12, whose features and function will be described in greater detail hereinafter, provides an interface between pressure regulation components 18 (not shown in FIG. 1, but see FIGS. 2 and 5) of the regulator 10 and a gas system to which the regulator 10 is connected. The base 12 is preferably manufactured from zinc #3 ingot, but it may be manufactured from other materials. The body 14, whose features and function shall be described in greater detail hereinafter, houses and supports the pressure regulation components 18 and safety components 20 (not shown in FIG. 1, but see FIGS. 2 and 6) of the regulator 10. The body 14 is preferably manufactured from aluminum bar alloy 2011-T3, but it may be manufactured from other materials. The bonnet 16, whose features and function will be described in greater detail hereinafter, covers and houses certain components of the pressure regulation components 18. The bonnet 16 is preferably manufactured from ZAMAK 3 zinc alloy, but it may be manufactured from other materials. Each individual component of the pressure regulation components 18 as well as the safety components 20 and its function shall be described hereinafter.

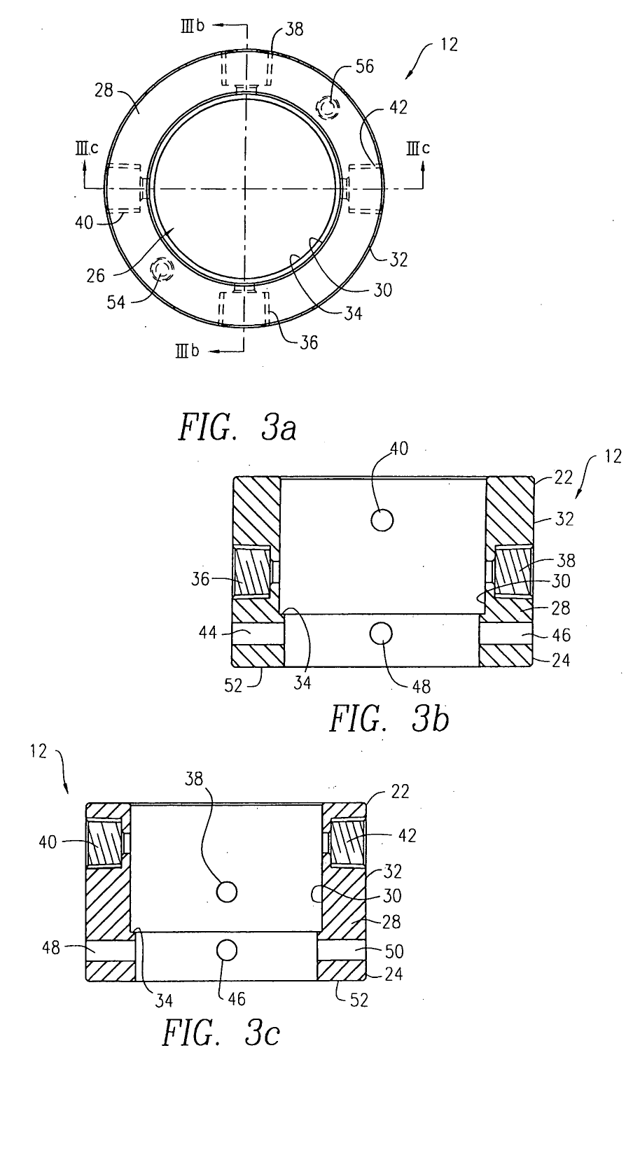

Referring to FIGS. 1, 2 and 3a through 3c, the base 12 includes a pair of ends 22, 24 and a cylindrical-shaped aperture 26 that extends longitudinally through the base 12 from the end 22 to the end 24. The aperture 26 is sized and dimensioned to accommodate the receipt and installation of the body 14 in the base 12. The base 12 further includes a base wall 28 having an inner surface 30 and an outer surface 32. The inner surface 30 of the base wall 28 surrounds the aperture 26, thereby forming a socket for the body 14. The base wall 28 is stepped proximate to the end 24 of the base 12, thereby forming an annular seat 34 whose function will be described hereinafter.

Still referring to FIGS. 1, 2 and 3a through 3c, the base 12 further includes a pair of diametrically opposed inlets 36, 38, each of which extends laterally through the base wall 28 from its outer surface 32 to its inner surface 30 and which terminates at the aperture 26. The base 12 further includes a pair of diametrically opposed outlets 40, 42, each of which extends laterally through the base wall 28 from its outer surface 32 to its inner surface 30 and which terminates at the aperture 26. The inlets 36, 38 are oriented perpendicularly relative to the outlets 40, 42 and on a common lateral plane that is intermediate the ends 22, 24 of the base 12. The outlets 40, 42 are also oriented on a common lateral plane, but one which is proximate the end 22 of the base 12. Each of the inlets 36, 38 and each of the outlets 40, 42 are internally threaded. Alternatively, the inlets 36, 38 and/or the outlets 40, 42 need not be threaded. The function of the inlets 36, 38 and the outlets 40, 42 will be described hereinafter.

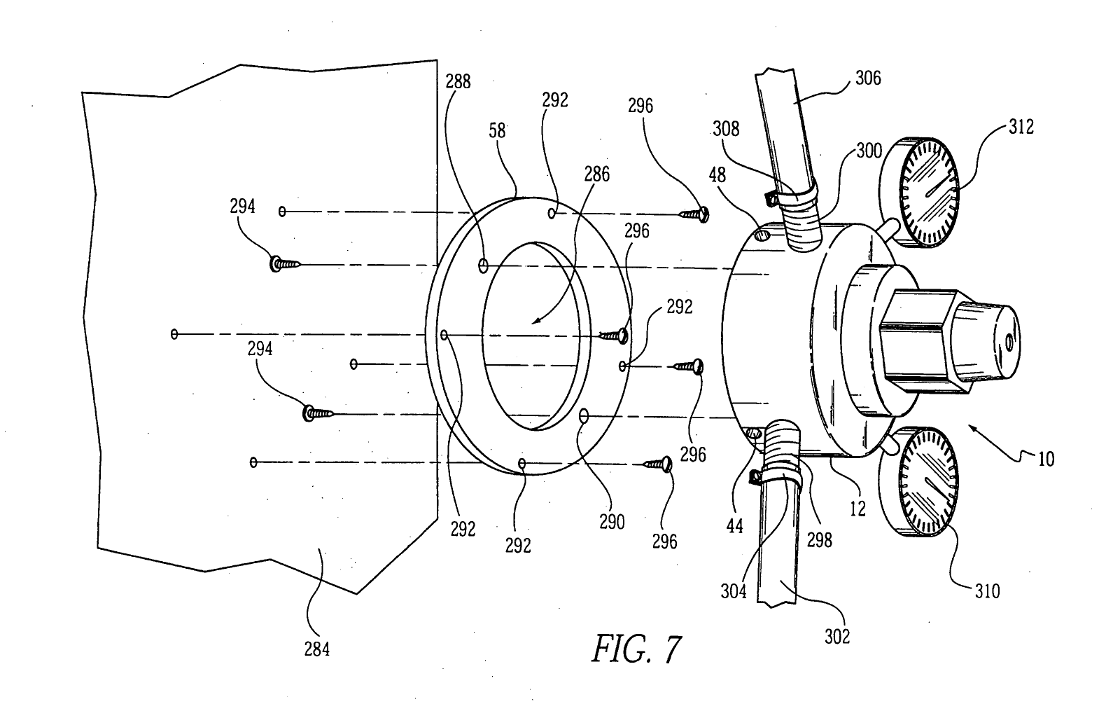

Still referring to FIGS. 1, 2 and 3a through 3c, the base 12 further includes cavities 44, 46, 48, 50, each of which extends laterally through the base wall 28 from its outer surface 32 to its inner surface 30 and which terminates at the aperture 26. More particularly, the cavity 44 is located proximate the inlet 36, while the cavity 46 is located proximate the inlet 38. Similarly, the cavity 48 is located proximate the outlet 40, while the cavity 50 is located proximate the outlet 42. The cavities 44, 46, 48, 50 are oriented on a common lateral plane that is proximate to the end 24 of the base 12. The function of the cavities 44, 46, 48, 50 shall be described hereinafter. Preferably, the base 12 includes the four cavities 44, 46, 48, 50, but it may include a greater or lesser number than four. A bottom surface 52 of the base 12 includes a pair of mounting holes 54, 56 for receipt of a mounting bracket 58 (not shown in FIGS. 1, 2 and 3a through 3c, but see FIG. 7) whose features and function will be described hereinafter.

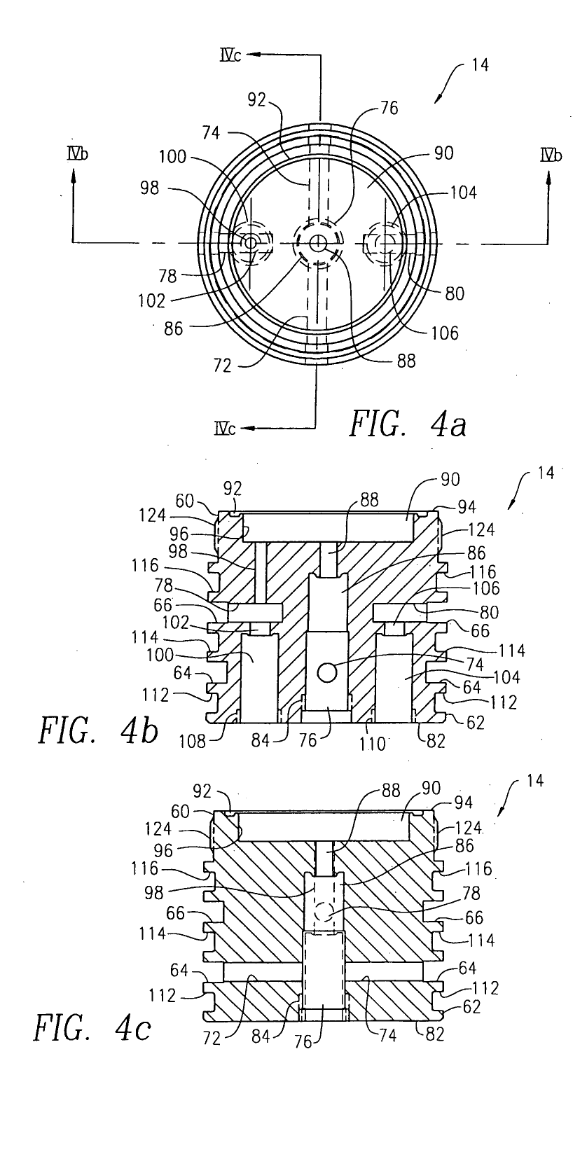

Referring now to FIGS. 2 and 4a through 4c, the body 14 includes a pair of ends 60, 62 and a pair of peripheral grooves 64, 66, each of which encircles the body 14. The peripheral groove 64 is located in a lateral plane that is proximate to the end 24 of the base 12, while the peripheral groove 66 is located in a lateral plane that is proximate to the end 22 of the base 12. When the body 14 is seated within the base 12 (as shown in FIG. 2), the peripheral groove 64 and the inner surface 30 of the base wall 28 form a ring-shaped (i.e., annular) inlet chamber 68, while the peripheral groove 66 and the inner surface 30 of the base wall 28 form a ring-shaped (i.e., annular) outlet chamber 70. When the body 14 is seated within the base 12 (as shown by FIG. 2), the inlet chamber 68 aligns with the inlets 36, 38, while the outlet chamber 70 aligns with the outlets 40, 42, irrespective of the relative radial orientation of the body 14 within the base 12. Alternatively, alignment means may be provided to allow the body 14 to be inserted into the base 12 to align the inlets 36, 38 with the inlet chamber 68 and to align the outlets 40, 42 with the outlet chamber 70. The function of the inlet chamber 68 and the outlet chamber 70 shall be described hereinafter.

Still referring to FIGS. 2 and 4a through 4c, the body 14 also includes a pair of diametrically opposed, cylindrical-shaped inlet passages 72, 74, whose function will be described hereinafter. The inlet passages 72, 74 are aligned with the peripheral groove 64 and extend laterally therefrom to a centrally located, cylindrical-shaped body plug chamber 76, whose function will be described hereinafter. The body 14 further includes a pair of diametrically opposed, cylindrical-shaped outlet passages 78, 80, whose function will be described hereinafter. The outlet passages 78, 80 are aligned with the peripheral groove 66 and extend laterally therefrom to a point that terminates within the body 14. When the body 14 is fully seated within the base 12 (as shown in FIG. 2), the inlet passage 72 aligns with the inlet 36 and the inlet passage 74 aligns with the inlet 38 (not shown in FIG. 2). Similarly, when the body 14 is fully seated within the base 12 (as shown in FIG. 2), the outlet passage 78 aligns with the outlet 40 and the outlet passage 80 aligns with the outlet 42 (see FIG. 2).

Still referring to FIGS. 2 and 4a through 4c, the body plug chamber 76 extends longitudinally from a bottom surface 82 of the body 14 to a point that terminates within the body 14. The body plug chamber 76 includes internal threads 84 proximate to the bottom surface 82 of the body 14 (see FIGS. 4b and 4c), the threads 84 performing a function which shall be described hereinafter. The body plug chamber 76 is directly connected to a centrally located, cylindrical-shaped stem spring chamber 86 that extends longitudinally within the body 14. The function of the stem spring chamber 86 shall be described hereinafter. A longitudinally extending, centrally located, cylindrical-shaped orifice 88 connects the stem spring chamber 86 to a centrally located, cylindrical-shaped diaphragm chamber 90, whose function shall be described hereinafter. An annular groove 92, whose function shall be described hereinafter, lies within a top surface 94 of the body 14 and is spaced outwardly from a sidewall 96 of the diaphragm chamber 90. A longitudinally extending, cylindrical-shaped passage 98 (see FIG. 4b) connects the diaphragm chamber 90 to the outlet passage 78, which is, in turn, connected to a cylindrical-shaped safety chamber 100 by a connecting passage 102. The safety chamber 100 extends longitudinally through the body 14 from the connecting passage 102 to the bottom surface 82 of the body 14. Similarly, the outlet passage 80 is connected to a cylindrical-shaped safety chamber 104 by a connecting passage 106. The safety chamber 104 extends longitudinally though the body 14 from the connecting passage 106 to the bottom surface 82 of the body 14. The safety chambers 100, 104 are specifically sized and shaped to house the safety components 20 of the regulator 10. So as to facilitate the mounting the safety components 20 in a manner to be described in greater detail hereinafter, the safety chamber 100 is provided with internal threads 108 proximate to the bottom surface 82 of the body 14, while the safety chamber 104 is provided with internal threads 110 proximate to the bottom surface 82 of the body 14.

Still referring to FIGS. 2 and 4a through 4c, the body 14 further includes three receiving slots 112, 114, 116, each of which encircles the periphery of the body 14. The receiving slot 112 is located between the end 62 of the body 14 and the peripheral groove 64. The receiving slot 114 is located between the peripheral grooves 64, 66. The receiving slot 116 is located between the peripheral groove 66 and the end 64 of the body 14. O-rings 118, 120, 122 (see FIG. 2), whose function shall be described hereinafter, are mounted within receiving slots 112, 114, 116, respectively. Alternatively, the O-rings 118, 120, 122 may be mounted to the inner surface 30 of the base wall 28. The O-rings 118, 120, 122 are preferably manufactured from Parker Compound N674-70 rubber and are supplied by Parker Hannifin Corporation, but can be made from other materials and/or supplied from other manufacturers. The upper end 60 of the body 14 further includes external threads 124 (see FIGS. 4b and 4c), whose function shall be described hereinafter.

Referring to FIGS. 1 and 2, the bonnet 16 includes an outer flange 126 and a hollow dome 128 that projects from the outer flange 126. The outer flange 126 includes internal threads 130 (see FIG. 2) that threadedly engage the external threads 124 of the body 14, thereby enabling the bonnet 16 to be removably fastened to the body 14. The dome 128 includes internal threads 132 and a centrally located bore 134, whose functions shall be described hereinafter.

Referring to FIGS. 2 and 5, the pressure regulation components 18 include a diaphragm assembly 136 consisting of a convoluted diaphragm 138, a diaphragm plate 140, a diaphragm gasket 142, a diaphragm post 144 and a relief spring 146. The diaphragm 138 includes an outer periphery 148 on which is formed an annular sealing bead 150, a single convolute 152, a centrally located shallow recess 154 and a central opening 156. The diaphragm 138 is positioned on the top surface 94 of the body 14 such that the annular sealing bead 150 of the diaphragm 138 is seated within the annular groove 92 of the body 14. The diaphragm 138 is preferably made from nitrile/polyester, but it can be made of other materials.

Still referring to FIGS. 2 and 5, the diaphragm plate 140 includes a flange 158, a raised central portion 160 and a central opening 162. The diaphragm plate 140 is centrally positioned on top of the diaphragm 138, whereby the flange 158 of the diaphragm plate 140 abuts against the convolute 152 of the diaphragm 138. Preferably, the diaphragm plate 140 is manufactured from DELRIN® brand acetal rod by E.I. du Pont, but it may be manufactured from other brands of acetal rod or other materials. The diaphragm gasket 142 is fitted around the convolute 152 of the diaphragm 138 and against the top surface 94 of the body 14, thereby sealing the diaphragm assembly 136 to the diaphragm chamber 90. The diaphragm gasket 142 is, preferably, manufactured from TEFLON® brand polytetraflouethylene (PTFE) by E.I. du Pont, but it can be made from other brands of PTFE or other materials.

Still referring to FIGS. 2 and 5, the diaphragm post 144, which is preferably manufactured from ZAMAK 3 zinc alloy, but can be manufactured from other materials, includes a post base 164 having a circular lip 166, a shaft 168 which extends longitudinally from the post base 164, a flanged head 170, a peripheral groove 172 located intermediate the shaft 168 and the flanged head 170, and a central internally threaded cavity 174 located within the shaft 168. The diaphragm post 144 is fitted within the central opening 156 of the diaphragm 138 and within the central opening 162 of the diaphragm plate 140, whereby the post base 164 abuts against the diaphragm 138, and the lip 166 of the diaphragm post 144 is positioned within the recess 154 of the diaphragm 138 and against the diaphragm plate 140. Once assembled as shown in FIG. 2, the lip 166 of the diaphragm post 144 limits the axial movement of the diaphragm 138, while the diaphragm post 144 promotes the centering of the diaphragm 138 and the diaphragm plate 140 in the body 14. The relief spring 146 is fitted around the diaphragm post 144 such that one end 176 of the relief spring 146 abuts the raised central portion 160 of the diaphragm plate 140, while an opposite end 178 of the relief spring 144 fits within the groove 172 and abuts against the flanged head 170 of the diaphragm post 144. The relief spring 146 is preferably manufactured from zinc plated music wire, but it can be manufactured from other materials.

Still referring to FIGS. 2 and 5, the pressure regulation components 18 also include a stem 180, a stem spring 182, a disc-shaped, porous filter 184 and a body plug 186, whose functions shall be described hereinafter. The stem 180 includes a shaft 188, an externally threaded head 190, and a flanged stem seat 192 having a radially extending flange 194. The externally threaded head 190 of the stem 180 threadedly engages the internally threaded cavity 174 of the diaphragm post 144. When the stem 180 and the diaphragm post 144 are coupled, the shaft 188 of the stem 180 is positioned within the orifice 88 of the body 14 (see FIG. 2) and the stem seat 192 of the stem 180 is positioned within the stem spring chamber 86 of the body 14 (see FIG. 2). The stem spring 182 is located within the stem spring chamber 86 of the body 14 such that one end 196 of the stem spring 182 is fitted around the stem seat 192 and abuts the flange 194 of the stem 180, while an opposite end 198 of the stem spring 182 abuts the filter 184, which is positioned within the body plug chamber 76 of the body 14. Preferably, the stem spring 182 is manufactured from zinc plated music wire, but it can be manufactured from other materials. The filter 184 is preferably disc-shaped, but it can consist of other shapes and sizes. In addition, the filter 184 is preferably manufactured from 10 micron sintered bronze 153, but can be manufactured from other materials.

Still referring to FIGS. 2 and 5, the body plug 186 includes a base 200, a shaft 202, an externally threaded flange 204 that extends radially from the shaft 202 and is located proximate to the base 200, and an unthreaded flange 206 that extends radially from the shaft 202 and is located distal from the base 200. The externally threaded flange 204 of the body plug 186 threadedly engages the internal threads 84 of the body plug chamber 76, thereby allowing the body plug 186 to be removably fastened to the body plug chamber 76. When the body plug 186 is fully inserted in the body plug chamber 76 of the body 14, the unthreaded flange 206 of the body plug 186 abuts the filter 184. The shaft 202 of the body plug 186 has a centrally located cavity 208 that runs longitudinally through the shaft 202. Two pairs of diametrically opposed holes 210, 212 extend laterally through the shaft 202 and communicate with the cavity 208. Alternatively, the body plug 186 may contain less or more than the two pairs of diametrically opposed holes 210, 212. When the body plug 186 is fully inserted in the body plug chamber 76 of the body 14 (as shown in FIG. 2), the holes 210, 212 of the body plug 186 align with the inlet chamber 68 of the body 14, irrespective of the radial orientation of the body plug 186 within the body plug chamber 76. The base 200 of the body plug 186 includes a plurality of notches 214 (not shown in FIG. 5, but see FIG. 2), which allow for the receipt of an assembly tool for fastening and unfastening the body plug 186 to and from the body plug chamber 76 of the body 14. The body plug 186 is preferably manufactured from round bar brass 360 alloy, but it can be manufactured from other materials.

Still referring to FIGS. 2 and 5, the pressure regulation components 18 further include a main compression spring 216 and a setscrew 218, which are fitted within the dome 128 of the bonnet 16. The function of the main compression spring 216 and setscrew 218 shall be described hereinafter. The setscrew 218 includes a radially extending, externally threaded flange 220, and a centrally located bore 222. The externally threaded flange 220 of the setscrew 218 threadedly engages the internal threads 132 of the dome 128 of the bonnet 16. The setscrew 218 is preferably manufactured from round bar brass 360 alloy, but can be manufactured from other materials. The main compression spring 216 extends longitudinally within the dome 128 of the bonnet 16 such that one end 224 of the main compression spring 216 abuts the flange 220 of the setscrew 218, while an opposite end 226 of the main compression spring 216 abuts the diaphragm plate 140, fitting within the flange 158 and around the raised central portion 160 of the diaphragm plate 140 as well as the shaft 168 of the diaphragm post 144 and the relief spring 146. The main compression spring 216 is preferably manufactured from zinc plated music wire, but can be manufactured from other materials.

Referring to FIGS. 2, 6a and 6b, the safety components 20 of the regulator 10 include a pair of safety seats 228, 230, a pair of safety springs 232, 234 and a pair of safety caps 236, 238, whose functions shall be described hereinafter. The safety seat 228 is positioned within the safety chamber 100 of the body 14, while the safety seat 230 is positioned within the safety chamber 104 of the body 14. The safety seat 228 includes a head 240, which has two pairs of diametrically opposed arms 242 and a centrally located depression 244, and a shaft 246, which has a centrally located orifice 248 that extends longitudinally through the shaft 246 and communicates directly with the depression 244. Similarly, the safety seat 230 includes a head 250, which has two pairs of diametrically opposed arms 252 and a centrally located depression 254, and a shaft 256, which has a centrally located orifice 258 that extends longitudinally through the shaft 256 and communicates directly with the depression 254. The arms 242, 252 of the safety seats 228, 230, respectively, promote centering of the safety seats 228, 230 within the safety chambers 100, 104, respectively. The first and second safety seats 228, 230 are, preferably, manufactured from DELRIN® brand acetal rod supplied by E.I. du Pont, but they can be made from other brands of acetal rod or other materials.

Still referring to FIGS. 2, 6a and 6b, the safety cap 236 includes a head 260, an inner unthreaded shaft 262 that extends longitudinally from the head 260 and has a centrally located bore 264 that extends longitudinally through the inner shaft 262, and an externally threaded, tubular outer shaft 266 that extends longitudinally from the head 260 and surrounds the inner shaft 262. Similarly, the safety cap 238 includes a head 268, an inner unthreaded shaft 270 that extends longitudinally from the head 268 and has a centrally located bore 272 that extends longitudinally through the inner shaft 270, and an externally threaded, tubular outer shaft 274 that extends longitudinally from the head 268 and surrounds the inner shaft 270. The externally threaded outer shaft 266 of the safety cap 236 threadedly engages the internal threads 108 of safety chamber 100, while the externally threaded outer shaft 274 of the safety cap 238 threadedly engages the internal threads 110 of the safety chamber 104, whereby the safety caps 236, 238 are removably fastened to and seal the safety chambers 100 and 104, respectively. The safety caps 236, 238 are preferably manufactured from round bar brass 360 alloy, but they can be manufactured from other materials.

Still referring to FIGS. 2, 6a and 6b, one end 276 of the safety spring 232 is fitted around the shaft 246 and abuts the head 240 of the safety seat 228, while an opposite end 278 of the safety spring 232 is fitted within the shaft 274 such that it surrounds the inner shaft 262 and abuts the head 260 of the safety cap 236. Similarly, one end 280 of the safety spring 234 is fitted around the shaft 256 and abuts the head 250 of the safety seat 230, while an opposite end 282 of the safety spring 234 is fitted within the shaft 274 such that it surrounds the inner shaft 270 and abuts the head 268 of the safety cap 238. The safety springs 232, 234 are preferably manufactured from spring steel wire SS 302, but they can be made of other materials.

Referring again to FIG. 2, the regulator 10 is assembled in the following manner. First, the pressure regulation components 18 and the safety components 20 are assembled and fitted within the body 14 and the bonnet 16 as previously described herein. Next, the bonnet 16 is fastened to the body 14, whereby the internal threads 130 of the outer flange 126 of the bonnet 16 threadedly engages the external threads 124 of the body 14, thereby enabling the bonnet 16 to be removably fastened to body 14. The setscrew 218 serves as an adjustment for the main compression spring 216 within the dome 128 of the bonnet 16. In this regard, the bore 134 in the dome 128 enables the receipt of a common tool, such as a hex wrench or screwdriver, to tighten or loosen the setscrew 218, thereby adjusting a longitudinal force produced by the main compression spring 216 against the diaphragm 138 and diaphragm plate 140, the effect of which shall be described hereinafter. The assembly consisting of the body 14, the bonnet 16, the pressure regulation components 18 and the safety components 20 is sometimes referred to herein as a “module.”

Next, the so-called module is installed within the base 12 by a simple plug-like action. When the module is fully installed within the base 12, the bottom surface 82 of the body 14 abuts the seat 34 of the base 12, whereby the inlets 36, 38 of the base 12 align with the inlet passages 72, 74 of the body 14, respectively (not shown in FIG. 2), while the outlets 40, 42 of the base 12 align with the outlet passages 78, 80 of the body 14, respectively. This orientation allows the inlets 36, 38 and the outlets 40, 42 to independently interface with the inlet passages 72, 74 and the outlet passages 78, 80, respectively. In addition, when the module is fully installed within the base 12, the O-rings 118, 120, 122 provide a gas-tight seal between the body 14 and the base 12 and between the inlet chamber 68 and the outlet chamber 70.

Referring now to FIG. 7, the regulator 10, as completely assembled, may be fastened to the mounting bracket 58 for mounting to a flat surface 284, such as a wall. The mounting bracket 58 includes a circular-shaped aperture 286, a pair of diametrically opposed regulator mounting holes 288, 290 and two pairs of diametrically opposed surface mounting holes 292. When the regulator 10 is fastened to the bracket 58, the aperture 286 of the mounting bracket 58 aligns with the aperture 26 of the base 12, while the mounting holes 288, 290 of the mounting bracket 58 align with the mounting holes 54, 56 of the base 12, respectively (not shown in FIG. 7). The aligned mounting hole 288 of the mounting bracket 58 and the mounting hole 54 of the base 12 receive one mounting screw 294, while the aligned mounting hole 290 of the mounting bracket 58 and the mounting hole 56 of the base 12 receive another mounting screw 294, thereby fastening the mounting bracket 58 to the bottom surface 52 of the base. Each of the surface mounting holes 292 of the mounting bracket 58 receives one of a plurality of surface mounting screws 296, which fasten the mounting bracket 58 to the flat surface 284. It is noteworthy that other fastening means are available to attach the mounting bracket 58 to the base 12 of the regulator 10 and/or the mounting bracket 58 to the flat surface 288. While the mounting bracket 58 is preferably manufactured from 14 gauge stainless steel, it can be made from other materials.

Still referring to FIG. 7, an externally threaded inlet coupling 298 threadedly engages the inlet 36 (not shown in FIG. 7) of the base 12, while an externally threaded outlet coupling 300 threadedly engages outlet 40 (not shown in FIG. 7) of the base 12. Alternatively, the inlet coupling 298 can be threadedly engaged with the inlet 38 (not shown in FIG. 7) and/or the outlet coupling 300 can be threadedly engaged to the outlet 42 (not shown in FIG. 7) of the base 12. An inlet hose 302 of the gas system is coupled to the inlet coupling 298 and preferably clamped by to the inlet coupling 298 by an inlet clamp 304. Similarly, an outlet hose 306 of the gas system is coupled to the outlet coupling 300 and preferably clamped to the outlet coupling 300 by an outlet clamp 308. In an alternative system, the inlet clamp 304 and/or the outlet clamp 308 need not be utilized. In addition, other clamping means are available to clamp the inlet hose 302 and the outlet hose 306 to the inlet coupling 298 and the outlet coupling 300, respectively. An inlet gauge 310, which measures and displays the pressure of the gas system flowing into the regulator 10, is fastened to the inlet 38 (not shown in FIG. 7). Similarly, an outlet gauge 312, which measures and displays the regulated output pressure of the gas exiting from the regulator 10, is fastened to the outlet 42 (not shown in FIG. 7). It should, of course, be understood that the inlet gauge 310 would be fastened to the inlet 36 when the inlet 38 is coupled to the gas system. In a similar alternative, the outlet gauge 312 would be fastened to the outlet 40 when the outlet 42 is coupled to the gas system. Alternatively, the inlet gauge 310 and/or the outlet gauge 312 need not be utilized. In such cases, the inlet 36 or the inlet 38 (as the case may be) and/or the outlet 40 or the outlet 42 (as the case may be) are capped by means known in the art. It is noteworthy that while several of the aforesaid components, such as the base 12, body 14, the aperture 26, etc., are described as being preferably cylindrical in shape, each can consist of other shapes and sizes.

Referring to FIGS. 2 and 7, when the gas system is turned on, gas flows from the inlet hose 302 into the inlet 36 of the base 12 and into the inlet chamber 68 of the body 14. The inlet gauge 310 connected to the inlet 38 measures and displays the input pressure of the gas flowing into the regulator 10. Next, the gas flows through the inlet passages 72, 74 of the body 14, through the diametrically opposed holes 210, 212 and into the cavity 208 of the body plug 186, and through the filter 184. The filter 184 prevents foreign matter from entering the stem spring chamber 86 and the orifice 88 of the body 14, thereby preventing blockage thereof and/or damage to the stem 180, which could result in misadjustment of or damage to the regulator 10. The gas then flows through the stem spring chamber 86 and the orifice 88, whereby the diameter of the shaft 188 of the stem 180 regulates the flow of the gas. In this regard, the larger the diameter of the shaft 188 of the stem 180, the lesser the flow rate of the gas through the regulator 10. Conversely, the smaller the diameter of the shaft 188 of the stem 180, the greater the flow rate of the gas through the regulator 10.

Next, the gas enters the diaphragm chamber 90 of the body 14, whereby the gas pressure created therein causes the diaphragm 138 to expand. The convolute 152 of the diaphragm 138 reduces stretching thereof (which can lead to tearing or rupturing of the diaphragm 138) when the gas pressure is present. When the diaphragm 138 expands, it forces the diaphragm plate 140 to travel longitudinally along the shaft 168 of the diaphragm post 144 in a direction away from the post base 164. The relief spring 146 creates a counteracting longitudinal force against the raised central portion 160 of the diaphragm plate 140, thereby limiting the travel of the diaphragm plate 140 along the shaft 168 of the diaphragm post 144. In addition, a counteracting longitudinal force produced by the main compression spring 216 against the diaphragm assembly 136 offsets the gas pressure, thereby limiting the distance that the diaphragm 138 can expand. When the gas pressure within the diaphragm chamber 90 decreases, the diaphragm 138 contracts and the relief spring 146 forces the diaphragm plate 140 to travel along the shaft 168 of the diaphragm post 144 towards the post base 164. As the diaphragm 138 cycles between expansion and contraction, the stem 180 modulates via the stem spring 182, continuously valving the gas through the regulator 10 and, accordingly, controlling the output pressure of the gas. The gas then travels out of the diaphragm chamber 90 through the passage 98 and into the outlet passage 78, through the outlet chamber 70 and out of the regulator 10 through outlet 40, and finally into and through the outlet hose 306 of the gas system. The outlet gauge 312 measures and displays the outlet pressure of the gas flowing out of the regulator 10.

In the event of the existence of any back pressure within the diaphragm chamber 90, or if a sufficient amount of debris is caught between the stem seat 192 of the stem 180 and/or orifice 88 (whereby a vacuum is created within the diaphragm chamber 90), the diaphragm 138 will burst and the gas will be relieved. In the event that excessive overpressure of gas occurs within the regulator 10, the safety components 20 provide relief therefor. In this manner, the overpressure of gas is released through the connecting passages 102, 106 and the depressions 244, 254 and orifices 248, 258 of the safety seats 228, 230, thereby causing the safety seats 228, 230 to travel longitudinally within the safety chambers 100, 104, respectively, towards the end 62 of the body 14. The safety springs 232, 234 ensure that the correct amount of pressure is relieved such that they limit the travel of the safety seats 228, 230 within the safety chambers 100, 104, respectively. The overpressure of gas then exits out of the bores 264, 272 of the heads 260, 268 of the safety caps 236, 238. The cavities 44, 46, 48, 50 of the base 12 allow for the disbursement of the overpressure of gas from the regulator 10, especially when the aperture 26 of the base 12 is impeded by the flat surface 284 to which the regulator 10 is mounted. By providing for the release of a substantial overpressure of gas in the foregoing manner, the safety components 20 prevent or reduce damage to the various components of the regulator 10 and to the gas system to which the regulator 10 is attached.

If maintenance or replacement of the regulator 10 is required, the module (i.e. the assembly consisting of the body 14, the bonnet 16, the pressure regulation components 18 and the safety components 20) may easily be removed from and installed in the base 12 without physical uncoupling the base 12 from the inlet hose 302 and the outlet hose 306 of the gas system. The pressure regulation components 18 and/or the safety components 20 may be readily replaced or disassembled for maintenance by removing the bonnet 16 from the body 14. For instance, if the filter 184, stem spring 182 and/or stem 180 need replacing, only the body plug 186 need be removed. Similarly, if one the safety seats 228, 230 and/or the safety springs 232, 234 needs replacement, then only the corresponding safety caps 236, 238 need be removed. Finally, if any component of the diaphragm assembly 136 and/or the main compression spring 216 needs replacement, then only the bonnet 16 need be removed. This eliminates the need to substantially disassemble the regulator components when replacing any of the aforesaid components. Consequently, this reduces both time and labor costs when maintenance or replacement of the regulator 10 is carried out.

It should be understood that the embodiment described herein is merely exemplary and that a person skilled in the art may make many variations and modifications without departing from the spirit and scope of the present invention. Accordingly, all such variations and modifications are intended to be included within the scope of the invention as defined in the appended claims.

1. In a fluid pressure regulator having a fluid inlet, a fluid outlet, an orifice of a first dimension disposed between said fluid inlet and said fluid outlet, and a stem of a second dimension extending through and disposed within said orifice, said second dimension being smaller than said first dimension such that said fluid pressure regulator exhibits a first flow capacity that depends, at least partially, on the relative sizes of said first and second dimensions, the improvement wherein said stem is selectively replaceable with another stem of a third dimension that is smaller than said first dimension and different than said second dimension, whereby the flow capacity of said fluid pressure regulator is selectively changeable from said first flow capacity to a second flow capacity that depends, at least partially, on the relative sizes of said first and third dimensions.

2. The fluid pressure regulator of claim 1, further comprising a flexible diaphragm disposed between said orifice and said fluid outlet, wherein said stem of a second dimension is operably coupled to said flexible diaphragm, and said stem of a second dimension is selectively detachable from said flexible diaphragm so as to permit said replacement of said stem of a second dimension with said stem of a third dimension.

3. The fluid pressure regulator of claim 2, further comprising a body having walls which at least partially define said orifice, wherein said flexible diaphragm is disposed within said body.

4. A method of changing the flow capacity of a fluid pressure regulator which includes a fluid inlet, a fluid outlet, an orifice of a first dimension disposed between said fluid inlet and said fluid outlet, and a first stem of a second dimension extending through and disposed within said orifice, said second dimension being smaller than said first dimension such that said fluid pressure regulator exhibits a first flow capacity that depends, at least partially, on the relative sizes of said first and second dimensions, said method comprising the steps of:
removing said first stem from said fluid pressure regulator; and
replacing said first stem with a second stem of a third dimension, said third dimension being smaller than said first dimension and different than said second dimension, whereby said fluid pressure regulator exhibits a second flow capacity that depends, at least partially, on the relative sizes of said first and third dimensions.

5. The method of claim 4, wherein said removing step includes removing said first stem from within said orifice in a direction opposite the direction of fluid flow through said orifice.

6. The method of claim 4, wherein said replacing step includes inserting said second stem into said orifice in the same direction as the direction of fluid flow through said orifice.

7. A method of changing the flow capacity of a fluid pressure regulator which includes a mounting base having a fluid inlet and a fluid outlet; and a first pressure control module coupled to said mounting base, said first pressure control module having an orifice of a first dimension disposed between said fluid inlet and said fluid outlet, and a stem of a second dimension extending through and disposed within said orifice, said second dimension being smaller than said first dimension such that said fluid pressure regulator exhibits a first flow capacity that depends, at least partially, on the relative sizes of said first and second dimensions, said method comprising the steps of:
removing said first pressure control module from said mounting base; and
replacing said first pressure control module with a second pressure control module having an orifice of said first dimension and a stem of a third dimension smaller than said first dimension and different than said second dimension, whereby said fluid pressure regulator exhibits a second flow capacity that depends, at least partially, on the relative sizes of said first and third dimensions.

8. A method of changing the flow capacity of a fluid pressure regulator which includes a mounting base having a fluid inlet and a fluid outlet; and a pressure control module coupled to said mounting base, said pressure control module having an orifice of a first dimension disposed between said fluid inlet and said fluid outlet, and a first stem of a second dimension extending through and disposed within said orifice, said second dimension being smaller than said first dimension such that said fluid pressure regulator exhibits a first flow capacity that depends, at least partially, on the relative sizes of said first and second dimensions, said method comprising the steps of:
detaching said pressure control module from said mounting base;
removing said first stem from said pressure control module;
replacing said first stem with a second stem of a third dimension, said third dimension being smaller than said first dimension and different than said second dimension; and
reattaching said pressure control module to said mounting base, whereby said fluid pressure regulator exhibits a second flow capacity that depends, at least partially, on the relative sizes of said first and third dimensions.

9. In a fluid pressure regulator having a fluid inlet, a fluid outlet, an orifice disposed between said fluid inlet and said fluid outlet so as to permit fluid to flow in a downstream direction through said orifice from said fluid inlet to said fluid outlet, a flexible diaphragm disposed downstream of said orifice, a diaphragm chamber at least partially defined by said flexible diaphragm, and a stem operably coupled to said flexible diaphragm and extending through said orifice, the improvement wherein said stem is detachably coupled to said flexible diaphragm such that, after detachment of said stem from said flexible diaphragm, said stem may be removed from said fluid pressure regulator without removing said flexible diaphragm.

10. The fluid pressure regulator of claim 9, further comprising a main compression spring located downstream of said orifice for counteracting a fluid pressure within said diaphragm chamber, and wherein said stem is removable from said fluid pressure regulator without removing said main compression spring.

11. The fluid pressure regulator of claim 10, further comprising a bonnet for retaining said compression spring, and wherein said stem is removable from said fluid pressure regulator without removing said bonnet.

12. The fluid pressure regulator of claim 9, wherein said stem is sized and shaped such that, after detachment of said stem from said diaphragm, said stem may be removed from said orifice in an upstream direction.

13. The fluid pressure regulator of claim 9, further comprising a post operably coupled to said flexible diaphragm, said stem being detachably coupled to said post.

14. The fluid pressure regulator of claim 13, wherein said post is movable relative to said flexible diaphragm.

15. The fluid pressure regulator of claim 13, wherein said post includes internal threads and said stem includes external threads which threadedly engage said internal threads such that said stem is detachably coupled to said post, said external threads of said stem being sized so as to permit removal of said stem from said orifice in said upstream direction.

16. A fluid pressure regulator, comprising a mounting base including a fluid inlet and a fluid outlet; and a pressure control module coupled to said mounting base, said pressure control module including a body, an orifice disposed within said body between said fluid inlet and said fluid outlet so as to permit a fluid to flow in a downstream direction through said orifice from said fluid inlet to said fluid outlet, and a filter disposed within said body between said orifice and said fluid inlet so as to permit at least a portion of the fluid to flow through said filter before flowing through said orifice.

17. The fluid pressure regulator of claim 16, further comprising a stem extending through and disposed within said orifice.

18. The fluid pressure regulator of claim 16, wherein said filter is removable from said body via a hole in said body disposed upstream of said orifice between said fluid inlet and said orifice.

19. The fluid pressure regulator of claim 16, further comprising a seat sized and shaped to close said orifice, said seat being disposed upstream of said orifice between said filter and said orifice.

20. A fluid pressure regulator, comprising a mounting base including a fluid inlet and a fluid outlet; and a pressure control module coupled to said mounting base and including a body, an orifice within said body between said fluid inlet and said fluid outlet so as to permit a fluid to flow in a downstream direction through said orifice from said fluid inlet to said fluid outlet, an access plug disposed in said body between said orifice and said fluid inlet and including a conduit formed in said plug so as to permit at least a portion of the fluid to flow through said plug before flowing through said orifice, and means for permitting said access plug to be removed from said body so as to provide access to a replaceable component of said pressure control module disposed at least partially upstream of said orifice.

21. The fluid pressure regulator of claim 20, wherein said replaceable component is a filter.

22. The fluid pressure regulator of claim 20, wherein said replaceable component is a stem extending through and disposed within said orifice.

23. The fluid pressure regulator of claim 20, wherein said replaceable component is a spring.
